(19) United States
(12) Patent Application Publication
(10) Pub. No.: US 2020/0074803 A1
(43) Pub. Date: Mar. 5, 2020

(54) Gaming System and Method for Card Game Having Virtual Sleeve

(71) Applicants: Robert L. Bronston, Bloomfield, MI (US); Erik W. Scharf, Miami, FL (US)

(72) Inventors: Robert L. Bronston, Bloomfield, MI (US); Erik W. Scharf, Miami, FL (US)

(21) Appl. No.: 16/120,537

(22) Filed: Sep. 4, 2018

(51) Int. Cl. G07F 17/32

(52) U.S. Cl. CPC G07F 17/3262; G07F 17/3293; G07F 17/3276; G07F 17/3211; G07F 17/3258; G07F 17/3209

(57) ABSTRACT

A gaming system and method for implementing a card game having a virtual sleeve is described. In one embodiment, the card game includes an electronic video poker game in which a player may, through the play of the cards, virtually cheat by removing one or more cards from the deck into a virtual sleeve during a hand. The cards stored in the virtual sleeve may be selectively re-inserted into another hand at a desirable time, such as during another card game, to improve the player's odds of winning a better payout. Additionally, the virtual sleeve can be associated with a user or player and may be carried or transferred between gaming systems of a network of gaming systems.

### TECHNICAL FIELD

This disclosure relates generally to electronic gaming systems, and, more particularly, to gaming systems and methods for operating a card game having a virtual sleeve.

### BACKGROUND

Electronic gaming systems, such as slot machines, video poker machines, video blackjack machines, and other electronic wagering game machines, provide a great deal of entertainment to both the active players and to those who watch the active play. Such gaming systems and types of game play are present at entertainment venues, at restaurants and bars, and as in-home entertainment.

Electronic gaming systems are modifiable and configurable so that traditional games and methods of playing a game may be further improved by abilities or features that are enabled by the use of processors and/or memory. For example, conventional card games, such as poker, blackjack, baccarat, etc. may be implemented in electronic gaming systems. The prior art describes many variants of electronic video poker games. Those games involve playing different versions of poker and allowing players to have access to various forms of bonus rounds.

While these various electronic video poker games provide some excitement and appeal to players relative to other known games, there is a continuing need to develop new features for gaming systems and methods to satisfy the demands of players and operators. The present embodiments describe methods, systems, and apparatus that provide for new and interesting gaming experiences, and that provide other advantages over the prior art.

### BRIEF DESCRIPTION OF THE DRAWINGS

The present disclosure can be better understood with reference to the following drawings and description. The components in the figures are not necessarily to scale, emphasis instead being placed upon illustrating the principles of the invention. Moreover, in the figures, like reference numerals designate corresponding parts throughout the different views.

FIG. 1 is a diagram of a network of gaming systems, according to an example embodiment.

FIG. 2 is a block diagram illustrating a representative gaming system for implementing a card game having a virtual sleeve, according to an example embodiment.

FIG. 3 is a diagram of a payout table for a card game, according to an example embodiment.

FIG. 4 is a representative view of a display of a gaming system showing a hand of a card game having a virtual sleeve, according to an example embodiment.

FIG. 5 is a representative view of a display of a gaming system showing another hand of a card game having a virtual sleeve, according to an example embodiment.

FIG. 6 is a representative view of a display of a gaming system showing another hand of a card game having a virtual sleeve, according to an example embodiment.

FIG. 7 is a representative view of a display of a gaming system showing another hand of a card game having a virtual sleeve, according to an example embodiment.

FIG. 8 is a representative view of a display of a gaming system showing a selected card being stored in a virtual sleeve, according to an example embodiment.

FIG. 9 is a representative view of a display of a gaming system showing a hand of a card game having a virtual sleeve with one stored card, according to an example embodiment.

FIG. 10 is a representative view of a display of a gaming system showing another hand of a card game having a virtual sleeve with one stored card, according to an example embodiment.

FIG. 11 is a representative view of a display of a gaming system showing a stored card from a virtual sleeve replacing a card in a hand of a card game, according to an example embodiment.

FIG. 12 is a representative view of a display of a gaming system showing a hand of a card game having a virtual sleeve with one stored card, according to an example embodiment.

FIG. 13 is a representative view of a display of a gaming system showing two cards being selected for storage in multiple slots of a virtual sleeve, according to an example embodiment.

FIG. 14 is a representative view of a display of a gaming system showing three selected cards being stored in slots of a virtual sleeve, according to an example embodiment.

FIG. 15 is a representative view of a display of a gaming system showing a hand of a card game having a virtual sleeve with three stored cards, according to an example embodiment.

FIG. 16 is a representative view of a display of a gaming system showing three stored cards from a virtual sleeve replacing cards in a hand of a card game, according to an example embodiment.

FIG. 17 is a flowchart of a method for implementing a card game having a virtual sleeve, according to an example embodiment.

### DESCRIPTION OF EXAMPLE EMBODIMENTS

Overview

Presented herein is a gaming system and method for implementing a card game having a virtual sleeve. In an example embodiment, a gaming system for implementing a card game having a virtual sleeve includes a display, at least one input device configured to receive inputs from a user of the gaming system, at least one processor in communication with the display and the at least one input device, and at least one memory in communication with the at least one processor. The at least one memory stores instructions that, when executed by the at least one processor, cause the at least one processor to initiate a first hand of a first card game. The first hand includes a plurality of cards dealt to a user of the gaming system, the plurality of cards being selected from a set of cards associated with the first card game. The instructions further cause the processor to receive an input from the user to implement a holdout feature in the first card game. The holdout feature allows the user to select at least one card of the plurality of cards from the first hand to store to a virtual sleeve. The processor is also caused to store the selected at least one card of the plurality of cards from the first hand in the virtual sleeve. The instructions further cause the processor to initiate a new hand of a second card game upon completion of the first card game. The processor also is caused to receive an input from the user to insert the selected at least one card from the first hand into the new hand of the second card game. The instructions also cause the processor to replace at least one card in the new hand with the selected at least one card from the first hand stored in the virtual sleeve.

### EXAMPLE EMBODIMENTS

As is well known in the art and as used herein, the term “gaming,” “gaming devices,” and/or “gaming systems” generally involves some form of wagering, and that players make wagers of value, whether actual currency or something else of value, e.g., a token or credit. Wagering-type games usually provide rewards based on random chance as opposed to skill. In some jurisdictions, the absence of skill when determining awards during game play is a requirement.

Various video poker gaming systems are described in the prior art, including, for example, U.S. Pat. Nos. 5,542,669; 5,531,441; 5,511,781; 5,100,137; and 5,033,744, the disclosures of which applications are incorporated herein by reference in their entirety. These prior art gaming systems illustrate the level of skill in the art and also illustrate that an adequate disclosure of a software modification to existing video poker gaming systems may consist of describing the high-level operation of the machine rather than circuitry details of a conventional design.

The gaming system and method according to the example embodiments described herein differs from the prior art in allowing the user or player to engage in virtual “cheating” or “card mechanics” by putting certain cards up a virtual “sleeve” and thereby removing those cards from the deck for purposes of any ordinary play (including subsequent hands) to follow, retaining the possibility of re-inserting the removed cards into the player's hand at an advantageous time.

As will be described in more detail below, according to the principles of the example embodiments, a player plays video poker (typically five-card draw, but other variants are possible) on an electronic gaming system that starts out by using a standard 52-card deck against a set pay-table (standard variants include Jacks or Better, Deuces Wild, Double Double Bonus, etc.). Based on the vagaries of play (for example, with a maximum coin/credit bet) the player is eligible to implement a holdout feature that allows the player to remove one or more selected cards from the deck and store them into a virtual sleeve for potential re-insertion into a hand in a desirable way at a later time, such as during a different hand or game.

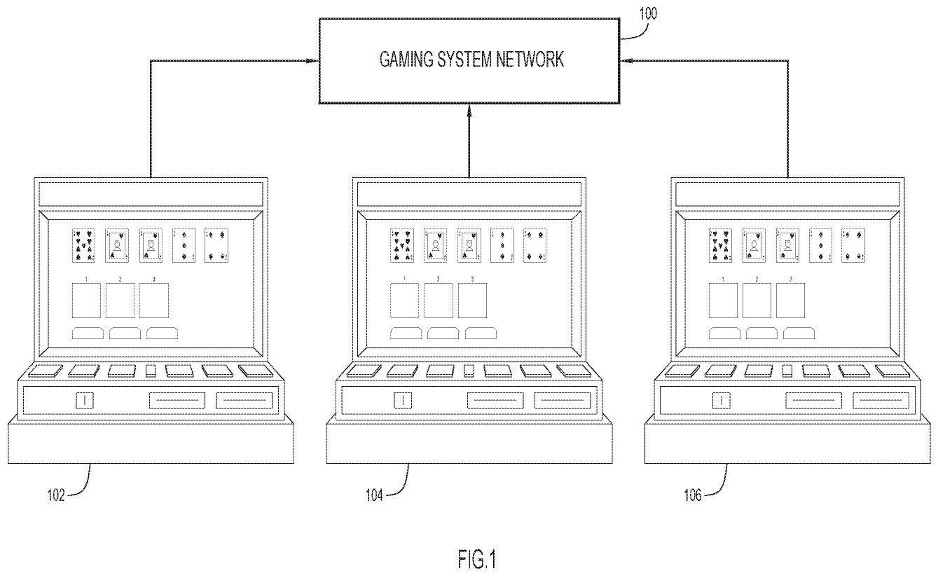

Referring now to FIG. 1, a gaming system network 100 including a plurality of gaming systems for implementing a card game having a virtual sleeve is shown according to an example embodiment. In some embodiments, gaming system network 100 may include a plurality of gaming systems that are interconnected or communicatively coupled with each other so that they may be collectively monitored, controlled, or otherwise linked together by a central controller of gaming system network 100. In this embodiment, gaming system network 100 includes a first gaming system 102, a second gaming system 104, and a third gaming system 106. One or more of first gaming system 102, second gaming system 104, and third gaming system 106 may be configured to implement a card game having a virtual sleeve in accordance with the principles of the example embodiments described herein.

Gaming system network 100 may include one or more servers and one or more databases in communication with plurality of gaming systems 102, 104, 106 and a central controller (not shown). Components of gaming system network 100 may be connected to one or more wired or wireless networks for communication between the components.

In some embodiments, gaming system network 100 may be associated with a progressive jackpot or similar shared prize pool accessible by the plurality of gaming systems in gaming system network 100. For example, a progressive jackpot is a jackpot to which value is added for every hand played until the jackpot condition (e.g., usually a Royal Flush) is achieved. Additionally, while gaming system network 100 is shown in FIG. 1 having three gaming systems, it should be understood that a gaming system network or bank of gaming systems may include any number of gaming systems or devices in various embodiments.

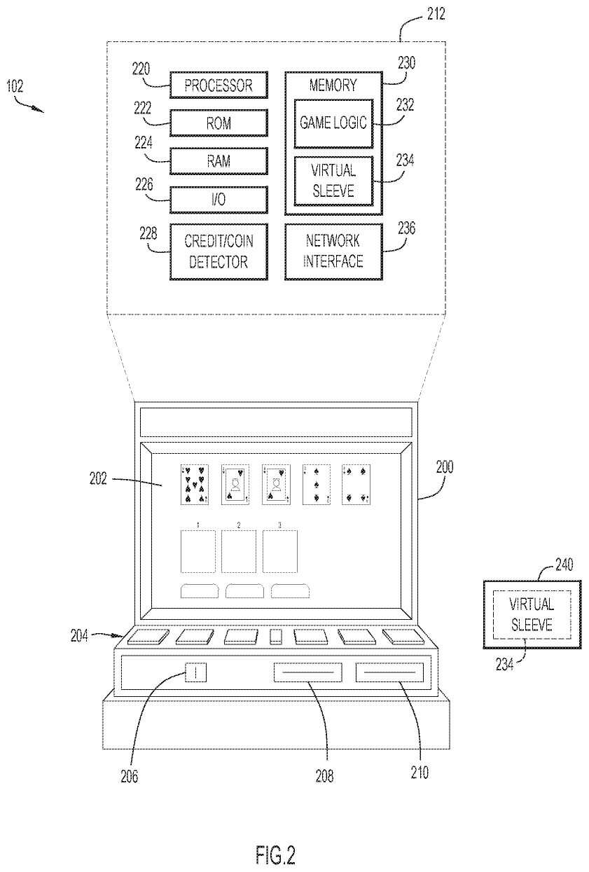

Referring now to FIG. 2, a block diagram of a representative gaming system, in this case, first gaming system 102, is shown for implementing a card game having a virtual sleeve, according to an example embodiment. In this embodiment, first gaming system 102 includes a housing 200 for holding the various components of first gaming system 102. The various components of first gaming system 102 may be connected directly to, or contained within, housing 200, as seen in FIG. 1. In other embodiments, some components may be located outside of housing 200 and connected to housing 200 using a variety of different wired or wireless connection techniques. Thus, first gaming system 102 includes these components whether physically contained within housing 200, or located outside of housing 200 and connected remotely.

First gaming system 102 includes various components that allow a user or player to interact with first gaming system 102. For example, in this embodiment, first gaming system 102 includes a display 202 and a plurality of input devices 204, such as push buttons, a keyboard, or other interface to allow a user or player to interact with first gaming system 102. In some embodiments, display 202 may be a touch screen display and a user or player may further provide input to first gaming system 102 via pressing appropriate areas on touch screen display 202.

First gaming system 102 may further include various interfaces for receiving currency, tokens, coins, cards, or other materials from a user or player. For example, as shown in FIG. 2. first gaming system 102 includes a currency slot 206 for receiving player coins, tokens, bills, or other currency, a card reader 208 for reading a credit card or other electronically readable card or voucher, such as a casino card or non-transitory, removable media storage device, and an output slot 210 for returning coins, receipts or other winnings to a player.

First gaming system 102 may further include a variety of internal mechanisms or circuitry for driving one or more gaming systems and methods described herein, as generally represented in computer system 212, contained within gaming system 102. Computer system 212 may be configured as would be known by a skilled artisan and may include, but is not limited to, a microprocessor or processor 220, ROM 222, RAM 224, one or more input/output drivers 226 (such as drivers for video, voice, touch screen, keyboard, card reader, etc.), a credit/coin detector 228 (which may be used to detect inputs from slot 206 and convert the currency to credits to be used by first gaming system 102), a memory 230, one or more network interfaces 236, as well as other types of memory known in the art such as flash memory or EEPROM (not shown). Stored in memory 230 (or elsewhere) of first gaming system 102 may include a game logic module 232 for implementing gaming methods (i.e., one or more different types of games, as well as associated rules and payout tables), and a virtual sleeve 234 for storing selected cards as part of a holdout feature to be implemented by a user or player, as described in more detail below.

Processor 220 may include one or more local or distributed processors, controllers, or virtual machines. As would be understood in the art, processor 220 may be configured in any convenient or desirable form as would be known by a skilled artisan. Memory 230 may comprise one or more electronic, magnetic, or optical data-storage devices, as well as game logic module 232 and virtual sleeve 234. As would be known in the art, memory 230 may store instructions, such as game logic module 232, for processing by processor 220. Game logic module 232 may include machine readable and/or executable instructions sets for performing and/or facilitating performance of methods and rendering graphical user interfaces as further described herein, including sharing one or more portions of this functionality in a client-server architecture, over a wireless or wireline communications network, for example, over gaming system network 100 via network interface 236. Network interface 236 may allow first gaming system 102 to communicate with one or more other gaming systems of gaming system network 100, including second gaming system 104 and/or third gaming system 106, as well as a central controller of gaming system network 100. Game logic module 232 may be embodied in a variety of known software systems, as would be known and implemented by a skilled artisan to effect the methods described herein.

In some embodiments, virtual sleeve 234 may additionally or alternatively be provided separately from first gaming system 102. For example, as shown in FIG. 2, in one embodiment, virtual sleeve 234 may be stored on a non-transitory, removable media storage device 240. With this arrangement, virtual sleeve 234 stored on non-transitory, removable media storage device 240 may be retained by a user or player as that user or player moves between various gaming systems, such as between any of the plurality of gaming systems 102, 104, 106 associated with gaming system network 100. Non-transitory, removable media storage device 240 storing virtual sleeve 234 may also permit a user or player to save cards in virtual sleeve 234 for later use during another gaming session separate from the gaming session where cards may have been saved to virtual sleeve 234. In still other embodiments, virtual sleeve 234 may be stored remotely and be associated with a user or player (e.g., using a password, identifier, casino card, etc.) for later retrieval.

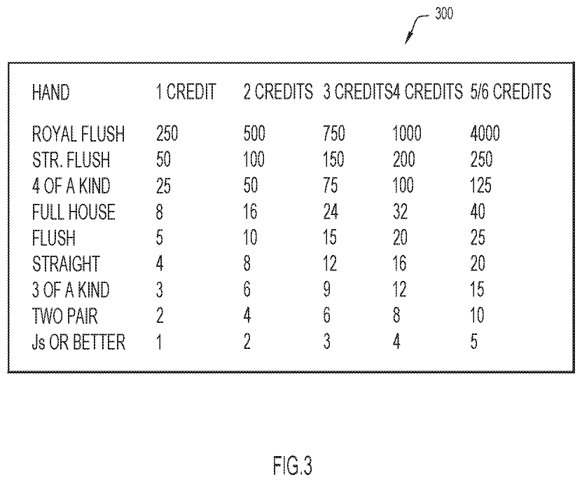

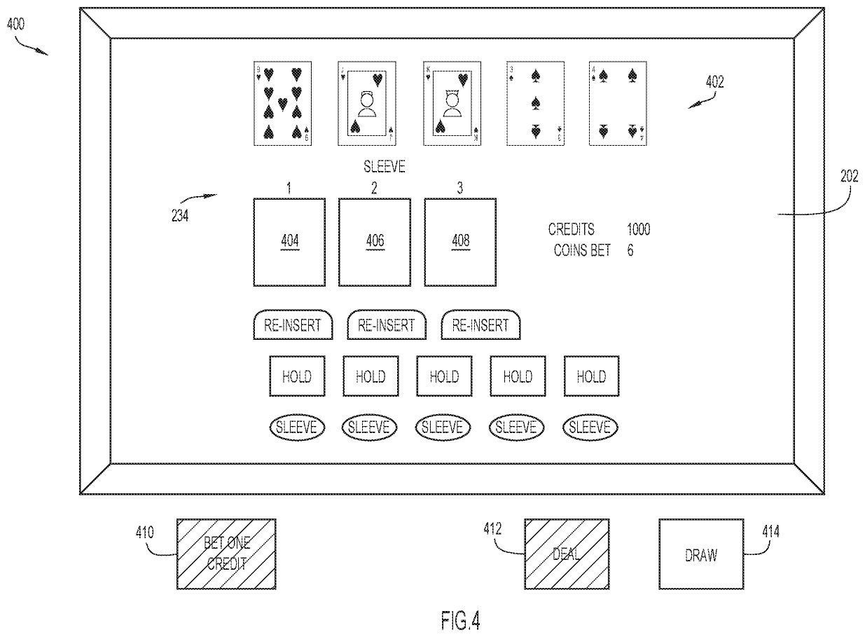

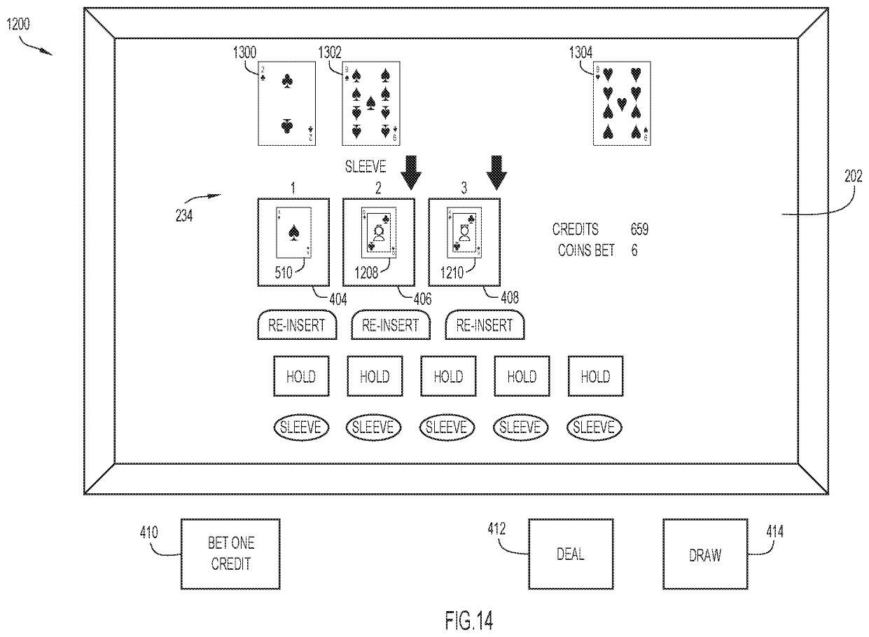

The example embodiments in this detailed description are based on a player that has chosen to play a specific poker card game, such as Jacks or Better, having a payout table 300 as shown in FIG. 3. It should be understood, however, that in other embodiments, a player may select any card game for implementing the holdout feature of the present embodiments to store one or more selected cards in a virtual sleeve, with each card game being associated with a set of rules and a payout table for awarding payouts for a wining hand. Next, the holdout feature of the example embodiments for implementing a card game having a virtual sleeve will be described in reference to the sequences of plays or hands shown in FIGS. 4-16 below.

In one embodiment, a player may play any number of hands betting five coins/credits or less according to payout table 300, but would not become eligible to utilize the holdout power (either removing or re-inserting a card) unless the player bets maximum coins/credits per hand, assumed in this example to be six coins. In these example embodiments, all bets are assumed to be maximum coins/credits per hand. Additionally, in FIGS. 4-16 below, plays of a card game (e.g., poker) may be implemented by an electronic video poker gaming system with a touch-sensitive screen, for example, first gaming system 102 having touch screen display 202. The player may choose from any number of variants of video poker as a base game, which, for the purposes of this description will be Jacks or Better, having payout table 300 as shown in FIG. 3, in the following Figures.

Referring now to FIG. 4, a previous hand 400 including a plurality of cards 402 is shown on touch screen display 202 of first gaming system 102. In this embodiment, a player has just finished previous hand 400 and, at this point, virtual sleeve 234 is empty with no cards stored in any of three available slots, including a first slot 404, a second slot 406, and a third slot 408. A new game begins when the player, having sufficient credits in the machine, presses a “Bet One Credit” button 410 a sufficient number of times to be eligible to implement the holdout feature (e.g., in this embodiment, a maximum 6 coins/credits wager) and presses a “Deal” button 412 or touches an indicated area of touch screen display 202.

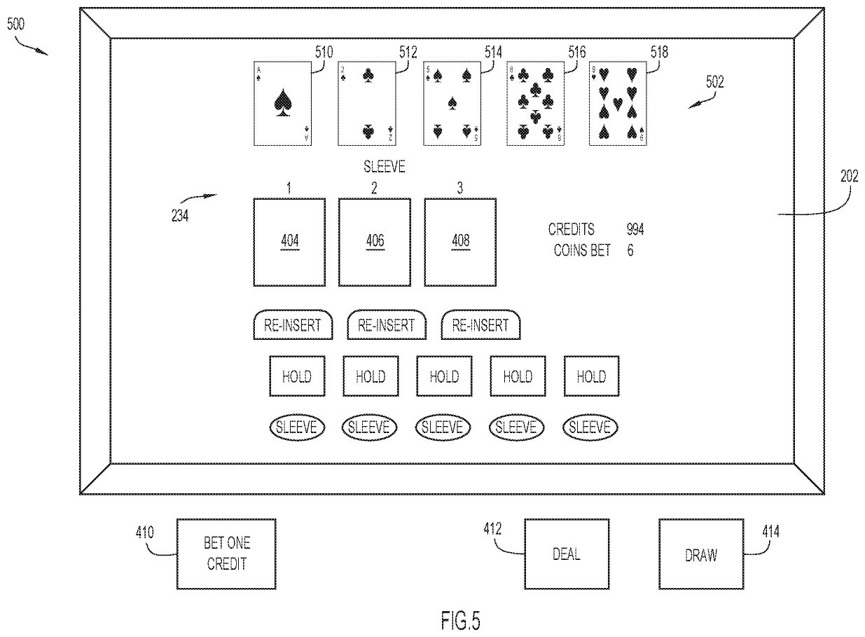

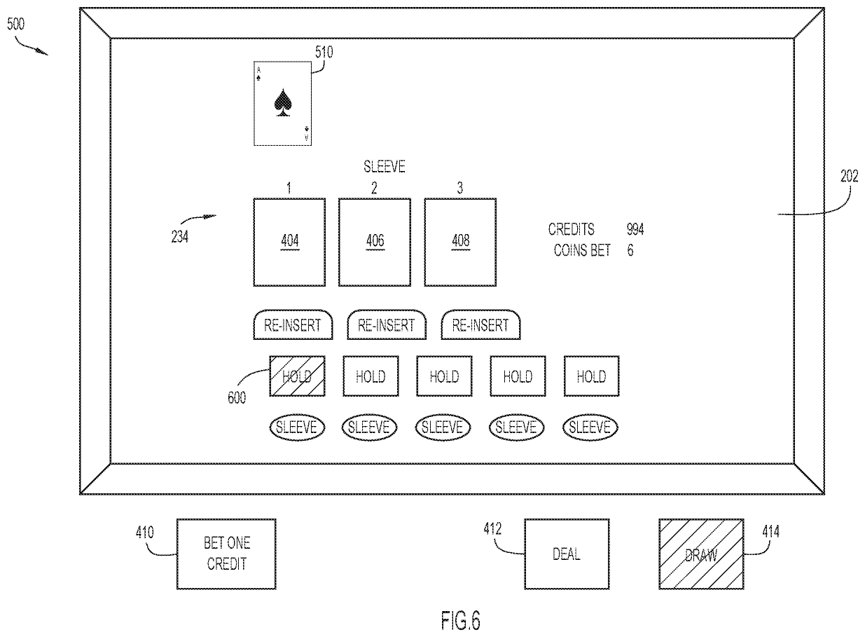

Next, FIG. 5 illustrates a play of a first hand 500 of a first card game, for example, Jacks or Better, as described above. In this embodiment, first hand 500 includes a plurality of cards (e.g., five cards), including an Ace of Spades 510, a Two of Clubs 512, a Five of Spades 514, an Eight of Clubs 516, and a Nine of Hearts 518. As shown in FIG. 6, the player decides to keep Ace of Spades 510 and to discard the other four cards 512, 514, 516, 518. For example, the player may touch a “Hold” area 600 of touch screen display 202 that corresponds to Ace of Spades 510 to hold that card, and leave the corresponding areas of touch screen display 202 for the other cards 512, 514, 516, 518 unselected to indicate that those cards may be discarded. Accordingly, the player may then press a “Draw” button 414 to receive four new cards to replace cards 512, 514, 516, 518.

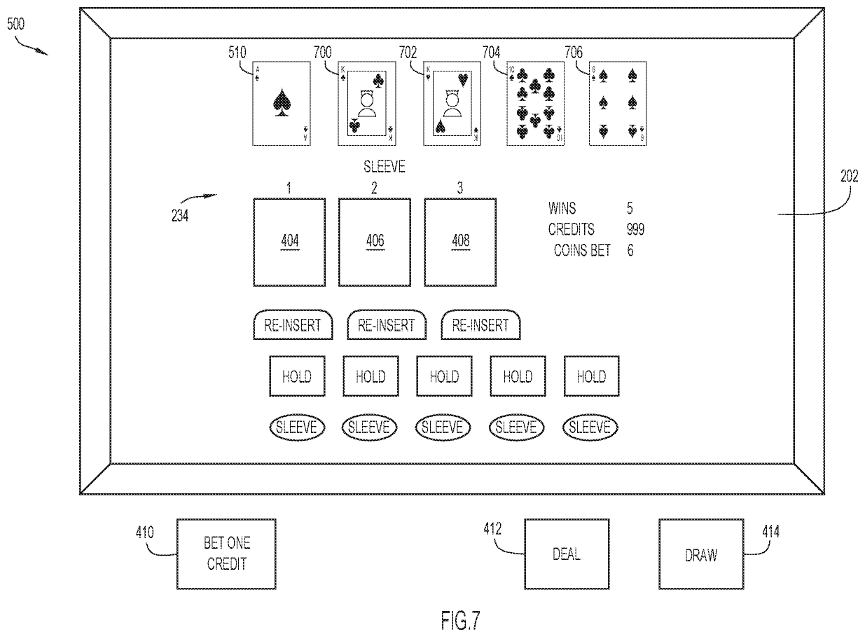

As shown in FIG. 7, the replacement cards are a King of Clubs 700, a King of Hearts 702, a Ten of Clubs 704, and a Six of Spades 706. Based on these cards in hand 500, the player would receive 5 coins/credits as a winning payout according to payout table 300 (i.e., a Pair of Kings receives a wining payout of 5 coins/credits, see FIG. 3). At the conclusion of hand 500, the player may decide to exercise the holdout feature by selecting Ace of Spades 510 to be stored in an available slot of virtual sleeve 234.

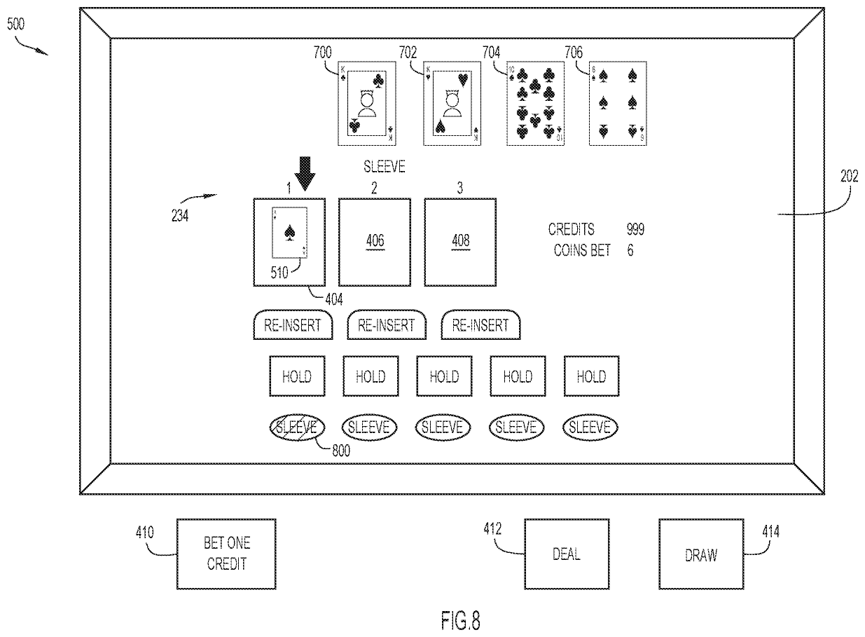

As shown in FIG. 8, the player implements the holdout feature by selecting Ace of Spades 510 to be stored in first slot 404 of virtual sleeve 234. For example, the holdout feature may be implemented by touching a “Sleeve” area 800 of touch screen display 202 that corresponds to Ace of Spades 510 to select that card to be stored in an available slot of virtual sleeve 234 (i.e., first slot 404 in this example).

FIG. 8 assumes that the player has already obtained the ability to implement the holdout feature to store a selected card to virtual sleeve 234. In various embodiments, there are many possible alternative methods for the player to acquire the ability to implement the holdout feature to select a card from the deck to add to virtual sleeve 234. Alternative embodiments include, but are not limited to, (1) having the holdout feature granted randomly, with a small chance of obtaining the holdout feature during every hand in which maximum coins/credits are bet, (2) being dealt a hand of a certain rank (i.e., Three-of-a-Kind or better), (3) achieving a hand of a certain rank after the draw (i.e., Four-of-a-Kind or better), (4) based on the length of time the player has played, (5) based on losses the player has accumulated, (6) based on the player having a dearth of good hands over a particular period of play (i.e., at least 250 hands since the player hit a hand of Four-of-a-Kind or better after the draw), (7) based on a “game within the game,” such as, for example, having certain of the playing cards contain “holdout” icons, and receiving a certain number of those cards post-draw provides the player the holdout feature, or (8) there may be no formal acquisition necessary, and the player automatically has the holdout feature whenever he or she begins play, for example, based on paying extra coins/credit per bet or agreeing to a different payout table having modified odds of winning or changed winning payout amounts to reflect the ability to use the holdout feature.

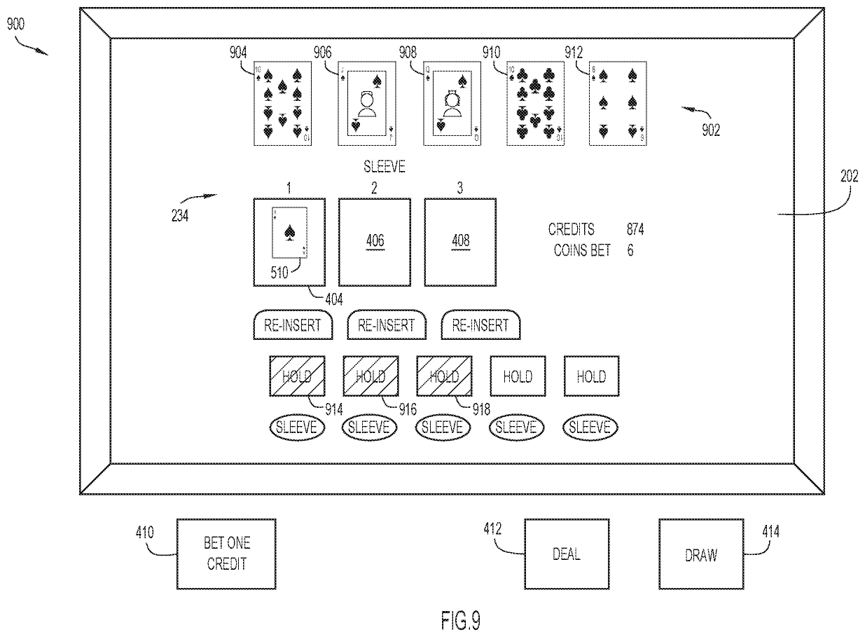

Upon completion of the first card game (i.e., first hand 500 shown in FIGS. 5-8), Ace of Spades 510 remains stored in first slot 404 of virtual sleeve 234 for use by the player during a new hand of a subsequent card game. The implementation of the holdout feature to replace a card in a hand by re-inserting a stored card saved in virtual sleeve 234 will now be described with reference to FIGS. 9-11 below.

Referring now to FIG. 9, later in the same session of play (i.e., upon completion of first hand 500 of the first card game), the player may start a second card game and receive a new hand 900 including a plurality of cards 902. In this embodiment, upon starting the second card game and receiving new hand 900, the player still has Ace of Spades 510 stored in first slot 404 of virtual sleeve 234. As shown in FIG. 9, plurality of cards 902 of new hand 900 includes a Ten of Spades 904, a Jack of Spades 906, a Queen of Spades 908, an Eight of Clubs 910, and a Six of Spades 912. The player selects Ten of Spades 904, Jack of Spades 906, and Queen of Spades 908 to keep by pressing or touching corresponding “Hold” areas of touch screen display 202 for each card that the player would like to keep. For example, as shown in FIG. 9, the player touches a “Hold” area 914 of touch screen display 202 that corresponds to Ten of Spades 904, a “Hold” area 916 that corresponds to Jack of Spades 906, and a “Hold” area 918 that corresponds to Queen of Spades 908 to hold those cards. The player leaves the corresponding areas of touch screen display 202 for the other cards 910, 912 unselected to indicate that those cards may be discarded. Accordingly, the player may then press “Draw” button 414 to receive two new cards to replace cards 910, 912 of new hand 900.

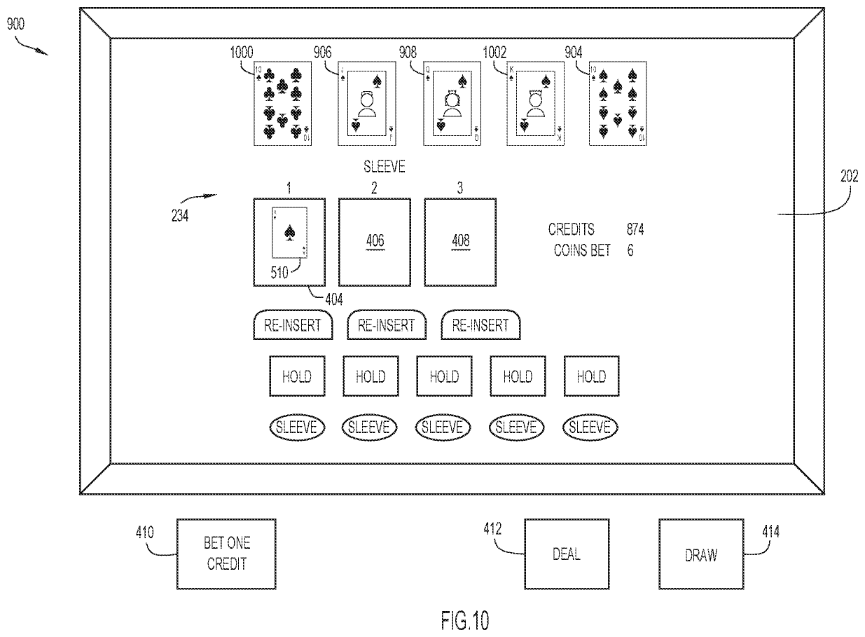

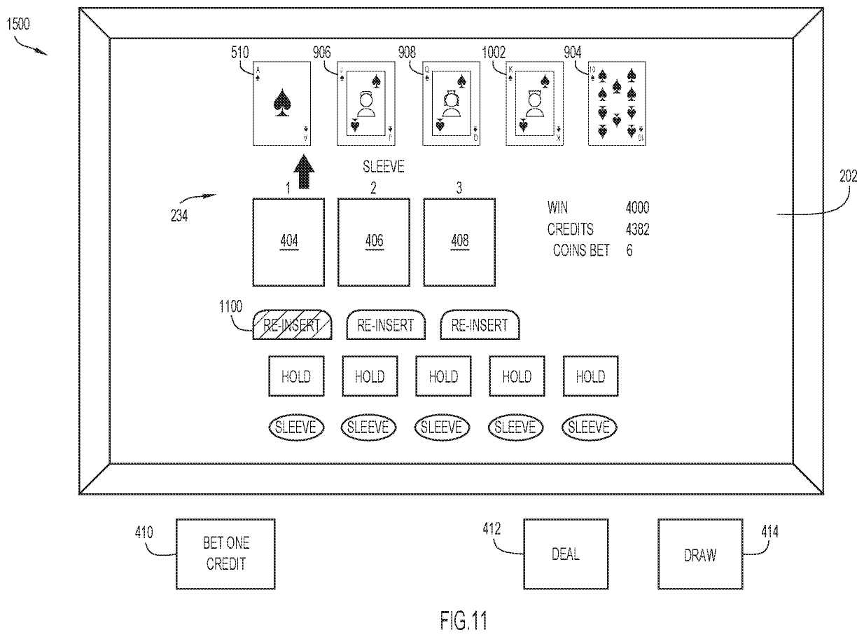

Next, as shown in FIG. 10, the player receives as replacement cards a Ten of Clubs 1000 and a King of Spades 1002. The resulting hand 900 includes a pair of tens (i.e., Ten of Spades 904 and Ten of Clubs 1000). According to payout table 300 shown in FIG. 3, a pair of tens does not result in a winning payout. However, the player retains Ace of Spades 510 stored in first slot 404 of virtual sleeve 234 and may implement the holdout feature of the present embodiments to affect hand 900. Accordingly, as shown in FIG. 11, the player may implement the holdout feature by selecting a “Re-Insert” area 1100 of touch screen display 202 that corresponds to first slot 404 of virtual sleeve 234 containing the stored Ace of Spades 510. As a result of implementing the holdout feature to re-insert Ace of Spades 510 from virtual sleeve 234 into the post-draw hand 900, Ten of Clubs 1000 is replaced with Ace of Spades 510. Now the player has hand 900 that includes a Royal Flush, which results in a wining payout of 4,000 coins/credits according to payout table 300 shown in FIG. 3 above.

With this arrangement, the holdout feature of the example embodiments permits the player to use a stored card in a slot of virtual sleeve 234 (e.g., Ace of Spades 510 stored in first slot 404) that was obtained during a previous card game (e.g., from first hand 500 of the first card game) to affect or change the outcome of a new hand during a subsequent card game (e.g., during hand 900 of the second card game). In this example, the implementation of the holdout feature changed a non-winning hand to a winning hand by re-inserting the stored card in virtual sleeve 234 into the non-winning hand. However, in other embodiments, the holdout feature may be used to improve a hand that already includes a winning payout to a better or higher winning payout.

FIGS. 4-11 above illustrate an example embodiment of implementing the holdout feature, including selecting a card to store in a slot of virtual sleeve 234 and subsequently re-inserting the stored card from virtual sleeve 234 into a new hand. In different embodiments, however, there are other possible variants for how cards can be removed from a hand and stored into virtual sleeve 234, as well as how cards stored in virtual sleeve 234 can be re-inserted into a hand.

In one embodiment, at the conclusion of the draw phase of a hand, a player who has obtained the ability to implement the holdout feature may choose to implement the holdout feature to store one or more cards in available slots of virtual sleeve 234 before the next hand is dealt (e.g., as shown in reference to FIGS. 5-8 above). In other embodiments, it is also possible to place limitations on circumstances in which a player may remove or store a card to virtual sleeve 234, such as a rule or requirement that a card can only be removed or stored to virtual sleeve 234 from a winning hand (i.e., a hand resulting in a winning payout).

Similarly, in one embodiment, the player has the option to implement the holdout feature to re-insert one or more of the cards stored in slots of virtual sleeve 234 into the hand only at the conclusion of the draw phase of a new hand (e.g., as shown in reference to FIGS. 9-11 above). In other embodiments, a player may have the option to implement the holdout feature to re-insert one or more of the cards stored in slots of virtual sleeve 234 into the hand at any point during the game, including before the draw phase of the hand. In these or other embodiments, a player may have the option to implement the holdout feature after the initial set of cards is dealt, either before or at the same time as the player selects which cards to hold and which to discard.

Additionally, as shown in FIG. 8, any card that the player selects to remove from a hand and store in a slot of virtual sleeve 234 is not replaced by a different card. However, in other embodiments, a replacement card may be dealt to the player. For example, as shown in FIG. 8, a replacement card may be dealt to replace Ace of Spades 510 that has been stored in first slot 404 of virtual sleeve 234. Accordingly, in these embodiments, the player may receive another card which may result in a winning payout or an improved wining payout for the hand.

Similarly, initiating the holdout feature to re-insert one or more cards stored in slots 404, 406, 408 of virtual sleeve 234 also may have different options for what happens to the replaced card. For example, in some embodiments, the card being replaced by the re-inserted card from virtual sleeve 234 may be switched into virtual sleeve 234 to take the place of the re-inserted card. In other embodiments, the card being replaced by the re-inserted card from virtual sleeve 234 may be returned to the pool of discarded cards.

In some embodiments, the holdout feature described herein may include multiple levels, such as levels 1, 2, or 3. Each level of the holdout feature allows the user or player to store an additional card in one of the at least three slots 404, 406, 408 of virtual sleeve 234. For example, level 1 of the holdout feature allows a player to store one card in a slot of virtual sleeve 234 (e.g., first slot 404 of virtual sleeve 234). Level 2 of the holdout feature allows the player to add an additional card to virtual sleeve 234, for example, storing a second card in another slot of virtual sleeve 234 (e.g., second slot 406). Similarly, level 3 of the holdout feature allows the player to add another additional card to virtual sleeve 234, for example, storing a third card in another slot of virtual sleeve 234 (e.g., third slot 408). It should be understood that additional slots may be added to virtual sleeve 234 in further embodiments.

Thus, in some embodiments, the number of cards that the player may store in virtual sleeve 234 (i.e., “hold out”) at any one time may be adjusted. Accordingly, in these embodiments, a player may start with the ability to remove/re-insert one card but may, over the course of play, “level up” and gain more advantageous variants or levels of the holdout feature, such as the ability to remove/re-insert multiple cards to or from slots of virtual sleeve 234.

Additionally, various embodiments of the holdout feature may include different durations for how long the holdout feature will last, including, but not limited to: (1) a set number of dealt hands (either uniform or randomly determined), (2) a set length of time (encouraging the player to play faster), (3) based on changes to the player's bankroll (i.e., the holdout feature ends after a set amount of coins/credits has been won or lost), (4) based on a certain rank of hand the player has achieved (i.e., the holdout feature ends when the player hits a hand of Four-of-a-Kind or higher in the post-draw phase), (5) indefinitely, or (6) until the player is “caught” cheating, which may have a probability of taking place during every hand that the player has selected cards to be stored in virtual sleeve 234 (i.e., the player is caught holding the card), or some probability of taking place when the player attempts to re-insert a card from virtual sleeve 234 into a hand (i.e., the player is caught using a held card). In other embodiments, the holdout feature may be continuously available to the player throughout its duration, or the player may only be able to implement the holdout feature only once or a limited number of times during its duration.

In embodiments where the player may retain various levels of the holdout feature indefinitely over time (i.e., over multiple hands and across different card games), mechanisms may be provided to allow the player's virtual sleeve status to be portable, for example, if the player needs to take a break during play or changes gaming machines. Such a portable mechanism may be achieved in different ways, including, for example, saving the player's virtual sleeve status on a PIN-protected casino player's card or storing virtual sleeve 234 on non-transitory, removable media storage device 240. With this arrangement, the player may resume play after a break by having the gaming system read the current status and level of the holdout feature associated with virtual sleeve 234 (including the presence of any stored cards) from the player's card or non-transitory, removable media storage device 240. Additionally, in some embodiments, the player may use this portable mechanism to take virtual sleeve 234 to a different gaming system than the gaming system where the stored cards were originally obtained, for example, using virtual sleeve 234 with any gaming system 102, 104, 106 in gaming system network 100, as shown in FIG. 1.

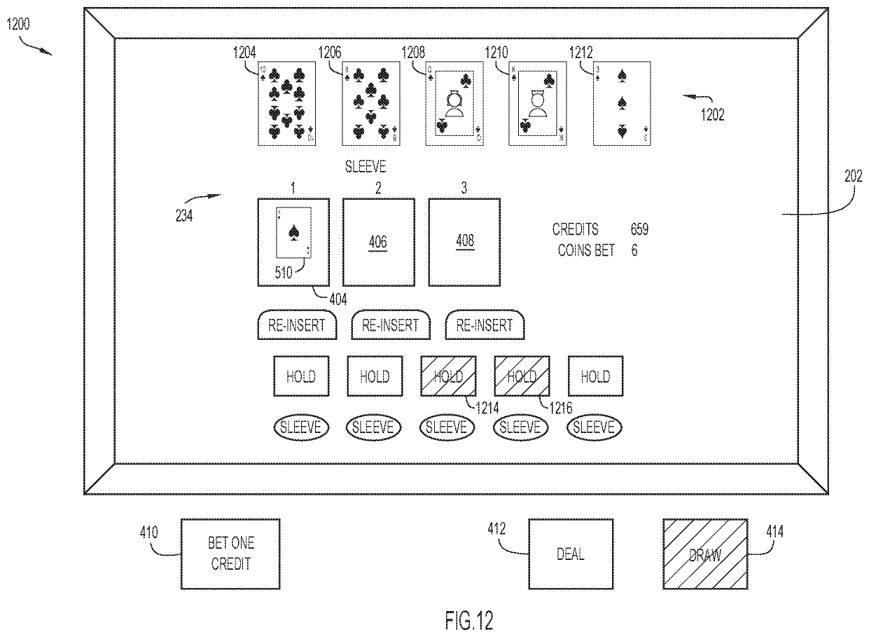

An example embodiment of implementing the holdout feature having multiple levels will now be described in reference to FIGS. 12-16 below. Referring now to FIG. 12, in this example, assume that a player begins a new hand 1200 with Ace of Spades 510 already stored in first slot 404 of virtual sleeve 234 and has obtained level 3 of the holdout feature (i.e., such that all three slots 404, 406, 408 in virtual sleeve 234 are available to the player).

As shown in FIG. 12, hand 1200 comprises a plurality of cards 1202, including a Ten of Clubs 1204, an Eight of Clubs 1206, a Queen of Spades 1208, a King of Spades 1210, and a Three of Spades 1212. In this embodiment, the player chooses to keep Queen of Spades 1208 and King of Spades 1210, and to discard the other three cards 1204, 1206, 1212. For example, the player may touch a “Hold” area 1214 of touch screen display 202 that corresponds to Queen of Spades 1208 and a “Hold” area 1216 that corresponds to King of Spades 1210 to hold those cards, while leaving the corresponding areas of touch screen display 202 for the other cards 1204, 1206, 1212 unselected to indicate that those cards may be discarded. Accordingly, the player may then press “Draw” button 414 to receive three new cards to replace cards 1204, 1206, 1212.

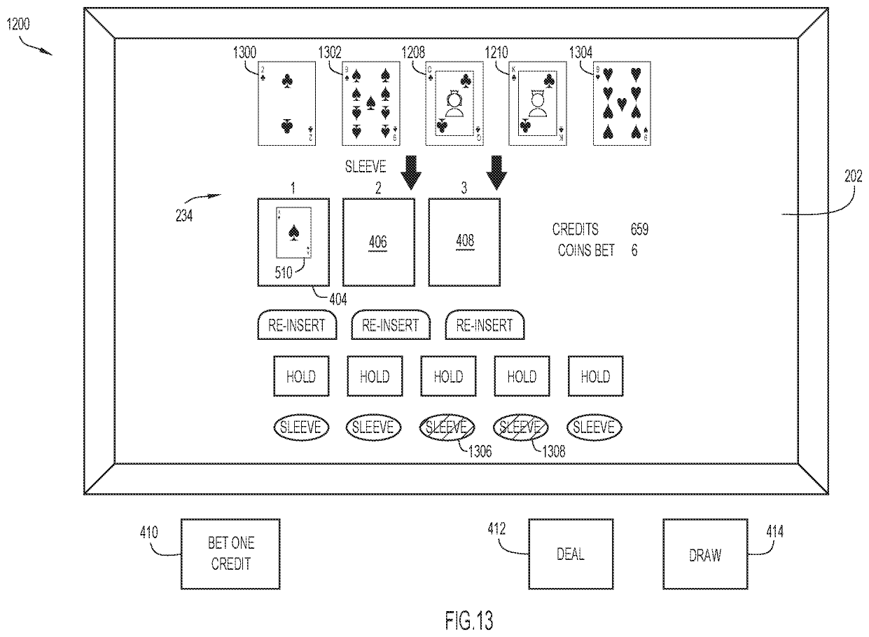

Next, as shown in FIG. 13, the player receives as replacement cards a Two of Clubs 1300, a Nine of Spades 1302, and a Nine of Hearts 1304. At this point, after the draw-phase, hand 1200 does not include a winning payout (e.g., according to payout table 300). The player may then exercise the holdout feature and select Queen of Spades 1208 and King of Spades 1210 to be stored in available slots of virtual sleeve 234. For example, the holdout feature may be implemented by touching a “Sleeve” area 1306 of touch screen display 202 that corresponds to Queen of Spades 1208 to select that card to be stored in an available slot of virtual sleeve 234 (i.e., second slot 406 in this example) and touching a “Sleeve” area 1308 of touch screen display 202 that corresponds to King of Spades 1210 to select that card to be stored in an available slot of virtual sleeve 234 (i.e., third slot 408).

Accordingly, upon completion of the card game (i.e., hand 1200 shown in FIGS. 12-14), Ace of Spades 510 remains stored in first slot 404 of virtual sleeve 234, Queen of Spades 1208 is stored in second slot 406 of virtual sleeve 234, and King of Spades 1210 is stored in third slot 408 of virtual sleeve 234. Thus, Ace of Spades 510, Queen of Spades 1208, and King of Spades 1210 are available in virtual sleeve 234 for use by the player during a new hand of a subsequent card game.

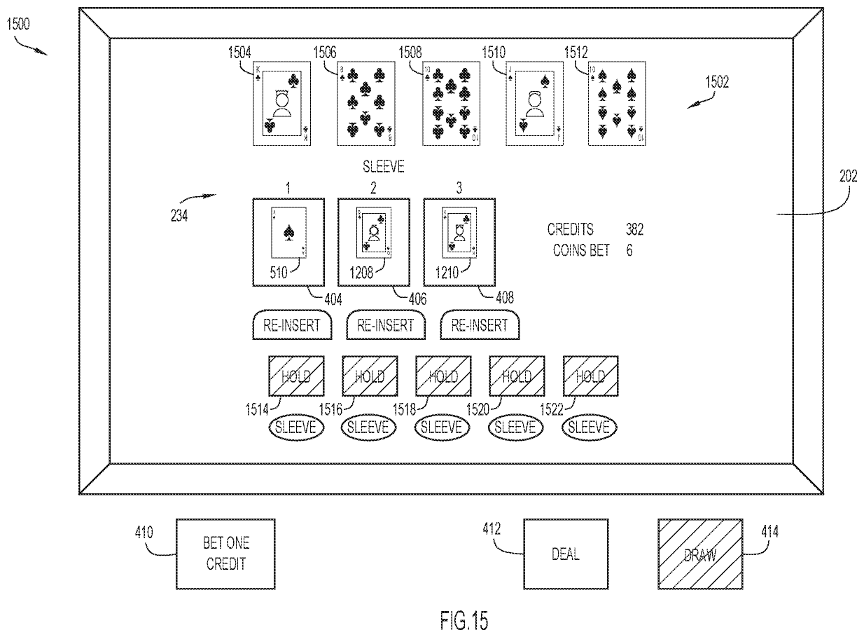

Later during a subsequent card game, which may be during the same play session on the same gaming system or during another play session on the same or different gaming system, the player is dealt a new hand 1500, as shown in FIG. 15. As described above, during a subsequent card game, the player has access to virtual sleeve 234, including stored cards 510, 1208, 1210 in slots 404, 406, 408. For example, in different embodiments, virtual sleeve 234 and associated status and level of the holdout feature may be stored on one or more gaming systems, stored remotely, stored on a player's casino card or non-transitory, removable media storage device 240, or otherwise available on a gaming system by being associated with the particular player.

In this embodiment, hand 1500 comprises a plurality of cards 1502, including a King of Clubs 1504, an Eight of Clubs 1506, a Ten of Clubs 1508, a Jack of Spades 1510, and a Ten of Spades 1512. As shown in FIG. 15, the player chooses to keep all five cards 1504, 1506, 1508, 1510, 1512. For example, the player may press a “Hold” area 1514 of touch screen display 202 that corresponds to King of Clubs 1504, a “Hold” area 1516 that corresponds to Eight of Clubs 1506, a “Hold” area 1518 that corresponds to Ten of Clubs 1508, a “Hold” area 1520 that corresponds to Jack of Spades 1510, and a “Hold” area 1522 that corresponds to Ten of Spades 1512 to hold all five cards. The player may then press “Draw” button 414 to waive drawing any replacement cards and to start the post-draw phase of hand 1500.

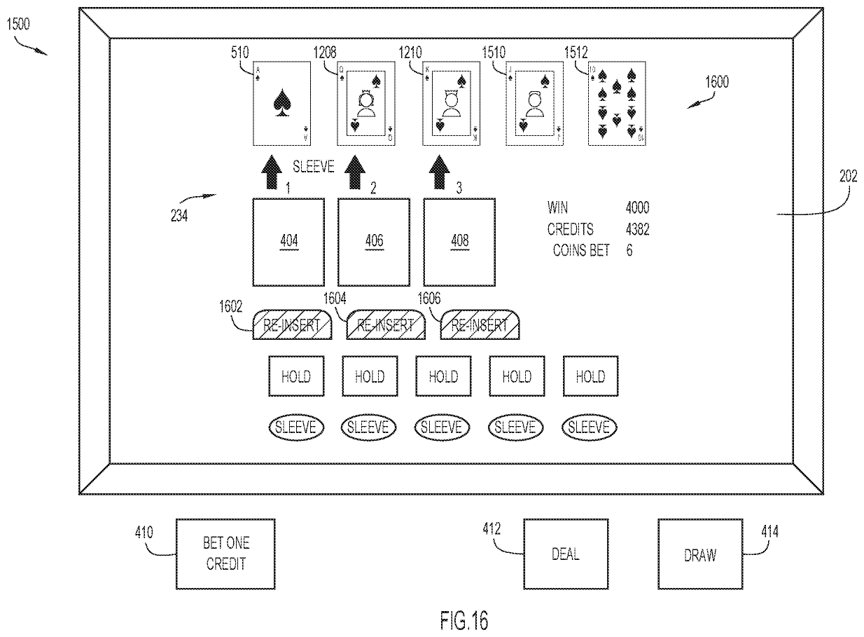

Next, as shown in FIG. 16, during the post-draw phase of hand 1500, the player may choose to implement the holdout feature to re-insert one or more cards from virtual sleeve 234 into hand 1500. In this embodiment, the player exercises the holdout feature to re-insert Ace of Spades 510 from first slot 404 of virtual sleeve 234, Queen of Spades 1208 from second slot 406 of virtual sleeve 234, and King of Spades 1210 from third slot 408 of virtual sleeve 234 into hand 1500, replacing, respectively, King of Clubs 1504, Eight of Clubs 1506, and Ten of Clubs 1508. For example, the player may implement the holdout feature by selecting a “Re-Insert” area 1602 of touch screen display 202 that corresponds to first slot 404 of virtual sleeve 234 containing the stored Ace of Spades 510, as well as selecting a “Re-Insert” area 1604 that corresponds to second slot 406 containing the stored Queen of Spades 1208 and a “Re-Insert” area 1606 that corresponds to third slot 408 containing the stored King of Spades 1210. In addition, in some embodiments, the player may also select which cards in hand 1500 are to be replaced by the re-inserted cards from virtual sleeve 234.

Upon re-insertion of stored cards 510, 1208, 1210 from virtual sleeve 234, the player's hand 1500 includes a Royal Flush 1600, which pays 4,000 coins/credits according to payout table 300, shown in FIG. 3. With this arrangement, the holdout feature of the example embodiments allows the player to use the stored cards in virtual sleeve 234 to change hand 1500 from a non-winning combination to Royal Flush 1600.

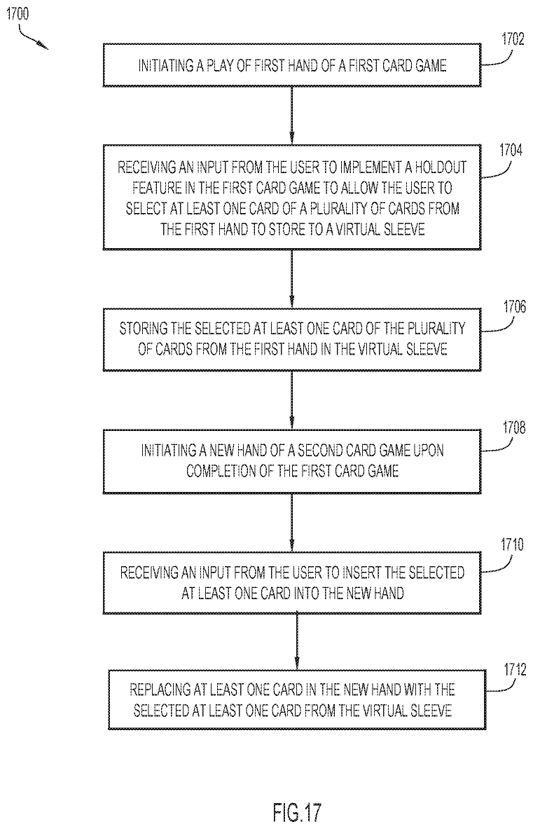

FIG. 17 illustrates a flowchart of method 1700 of implementing the holdout feature of the example embodiments described herein. In some embodiments, method 1700 may be implemented by a gaming system, for example, gaming system 102, shown in FIGS. 1-2 above. In other embodiments, method 1700 may be implemented by any one or more gaming systems associated with a common gaming system network, for example, any of gaming systems 102, 104, 106 associated with gaming system network 100, shown in FIG. 1.

In this embodiment, method 1700 may begin at an operation 1702 where a play of a first hand of a first card game is initiated. Next, method 1700 includes an operation 1704 where an input is received from a user or player to implement a holdout feature in the first card game to allow the user or player to select at least one card of a plurality of cards from the first hand to be stored in a virtual sleeve. For example, as described above in reference to FIG. 8, the player implements the holdout feature to select Ace of Spades 510 to be stored to virtual sleeve 234 by pressing “Sleeve” area 800 on touch screen display 202.

Next, method 1700 includes an operation 1706, where the selected at least one card from the first hand is stored to the virtual sleeve. For example, as shown in FIGS. 8-15 above, Ace of Spades 510 is stored in first slot 404 of virtual sleeve 234. At this point in method 1700, the player has stored at least one card in the virtual sleeve (e.g., virtual sleeve 234) and may choose to implement the holdout feature during a new hand of a subsequent card game as desired to re-insert one or more of the stored cards in the virtual sleeve.

Method 1700 may proceed to an operation 1708 where the player initiates a new hand of a second card game upon completion of the first card game. It should be understood that while method 1700 and operation 1708 describe a second card game, the holdout feature may be implemented during any subsequent card game initiated after the completion of the card game in which the player has chosen to implement the holdout feature to store one or more cards to the virtual sleeve. At an operation 1710, method 1700 includes receiving an input from the user or player to insert the selected at least one card stored in the virtual sleeve into the new hand. In other words, at operation 1710, the player has chosen to implement the holdout feature of the example embodiments to re-insert one or more stored cards saved to slots 404, 406, 408 of virtual sleeve 234 into the player's hand. For example, as shown in reference to FIG. 11, described above.

At an operation 1712 method 1700 includes replacing at least one card in the new hand with the selected at least one card from the virtual sleeve. For example, as shown in FIG. 11, upon selection of “Re-insert” area 1100 of touch screen display 202, Ace of Spades 510 has been re-inserted from first slot 404 of virtual sleeve 234, thereby replacing Ten of Clubs 1000 in hand 900. In some embodiments, for example, where the holdout feature has multiple levels (i.e., multiple cards are stored in slots 404, 406, 408 of virtual sleeve 234), method 1700 may further include additional operations similar to operations 1704, 1706, 1710, 1712 for each additional card that is to be stored and/or re-inserted from the virtual sleeve.

The above description of the principles of the example embodiments for implementing a holdout feature in a card game having a virtual sleeve has been described in reference to the embodiments shown in FIGS. 1-17. Other embodiments may include different variations or combinations of variations on the principles of the example embodiments. For example, any one or more of the variations described below may be implemented with the holdout feature of the example embodiments.

In one variant of the example embodiments, a player may use the holdout feature to remove a large number of cards from the deck over a period of time without having the ability to re-insert the removed cards. In this variant, a player's goal would be to remove disfavored cards from the deck, thereby increasing the concentration in the deck of favored cards, such as those that might produce a Royal Flush or other winning payout.

In some embodiments, the player may have the ability or option to continually view the one or more cards that are stored in virtual sleeve 234. For example, as shown in the Figures above, display 202 may include an area configured to constantly display virtual sleeve 234 to the player during each hand of one or more card games. In other embodiments, however, virtual sleeve 234 may only be visible upon request by the player or upon the occurrence of some event or condition during the card game, for example, being visible only during the post-draw phase.

In another variant, the holdout feature may further include the ability or option to alter one or more of the held-out card(s) (i.e., stored cards in virtual sleeve 234) in some way. For example, by changing one or more of a rank and suit of one of the stored cards in virtual sleeve 234.

In another variant, the holdout feature may further include the ability or option to re-use the same held-out card by re-inserting it into several hands over a period of time. For example, in this variant, Ace of Spades 510 may be re-inserted from first slot 404 of virtual sleeve 234 into multiple hands on different occasions, such as during different card games.

In still another variant, the player may be “caught cheating” when choosing to implement the holdout feature. For example, a computer algorithm may be used to detect cheating. The algorithm could be based on various factors, including, but not limited to: the value of the held-out card (i.e., an Ace is more valuable to the player than a 7); the length of time the card is held out; the value of the hand created by re-inserting the held-out card; or a random-number generator.

In some embodiments, the odds of the player being “caught” for cheating may be based on an algorithm that evaluates the similarity of the stored card from the virtual sleeve being re-inserted to the card being replaced by it. For example, if the player has a Ten of Diamonds stored in virtual sleeve 234, replacing the Nine of Hearts with the stored card in virtual sleeve 234 is less likely to be caught, as both are red cards with similar rank/value. Replacing a Queen of Spades, on the other hand, would be much more likely to be caught, because the cards are more dissimilar, i.e., different in both suit, color, and rank/value.

In another variant, the player may be provided “tips” for using the holdout feature during a card game. For example, processor 220 of first gaming system 102 may provide the player with information about the state of play, such as the strategically correct way of playing a hand or the odds of hitting a Royal Flush over the next 50 hands given the suit and rank of the stored cards in virtual sleeve 234.

In another variant, the payout table may be dynamically changed based on the holdout feature. For example, a computer algorithm may change the payout table for the card game being played based on the value of the held-out card(s) (i.e., stored cards in virtual sleeve 234). With this arrangement, the value of winning payouts (e.g., as shown in payout table 300 of FIG. 3) may change dynamically during play based on the stored cards in virtual sleeve 234.

In another variant, the holdout feature may require the player to insert additional coins/credits to use based on the value of the card(s) being held out, including paying additional coins/credits to store one or more cards to virtual sleeve 234 and/or paying additional coins/credits to re-insert one or more stored cards from virtual sleeve 234 into a player's hand.

In some embodiments, a payout table may be adjusted or have a new entry included for a winning payout that includes a card that was re-inserted using the holdout feature. For example, a new entry in payout table 300 may be added for a Royal Flush obtained by inserting a card from virtual sleeve 234. In such embodiments, the winning payout may be less than the conventional winning payout without use of the holdout feature.

Other systems, methods, features and advantages of the example embodiments will be, or will become, apparent to one of ordinary skill in the art upon examination of the above figures and detailed description. It is intended that all such additional systems, methods, features and advantages be included within this description and this summary, be within the scope of the present disclosure, and be protected by the following claims.

In summary, a gaming system is provided comprising: a display; at least one input device configured to receive inputs from a user of the gaming system; at least one processor in communication with the display and the at least one input device; and at least one memory in communication with the at least one processor, wherein the at least one memory stores instructions that, when executed by the at least one processor, cause the at least one processor to: initiate a first hand of a first card game, wherein the first hand includes a plurality of cards dealt to a user of the gaming system, the plurality of cards being selected from a set of cards associated with the first card game; receive an input from the user to implement a holdout feature in the first card game, wherein the holdout feature allows the user to select at least one card of the plurality of cards from the first hand to store to a virtual sleeve; store the selected at least one card of the plurality of cards from the first hand in the virtual sleeve; initiate a new hand of a second card game, the second card game being initiated upon completion of the first card game; receive an input from the user to insert the selected at least one card from the first hand into the new hand of the second card game; and replace at least one card in the new hand with the selected at least one card from the first hand stored in the virtual sleeve.

In addition, a method of operating a gaming system comprising a display, at least one input device, a processor, and a memory is provided, the method comprising: initiating, by the at least one processor of the gaming system, a first hand of a first card game, wherein the first hand includes a plurality of cards dealt to a user of the gaming system, the plurality of cards being selected from a set of cards associated with the first card game; receiving an input from the user to implement a holdout feature in the first card game, wherein the holdout feature allows the user to select at least one card of the plurality of cards from the first hand to store to a virtual sleeve; storing the selected at least one card of the plurality of cards from the first hand in the virtual sleeve; initiating a new hand of a second card game, the second card game being initiated upon completion of the first card game; receiving an input from the user to insert the selected at least one card from the first hand into the new hand of the second card game; and replacing at least one card in the new hand with the selected at least one card from the first hand stored in the virtual sleeve.

Furthermore, a non-transitory computer readable storage media encoded with instructions is provided that, when executed by a processor of a gaming system, cause the processor to perform operations comprising: initiating a first hand of a first card game, wherein the first hand includes a plurality of cards dealt to a user of the gaming system, the plurality of cards being selected from a set of cards associated with the first card game; receiving an input from the user to implement a holdout feature in the first card game, wherein the holdout feature allows the user to select at least one card of the plurality of cards from the first hand to store to a virtual sleeve; storing the selected at least one card of the plurality of cards from the first hand in the virtual sleeve; initiating a new hand of a second card game, the second card game being initiated upon completion of the first card game; receiving an input from the user to insert the selected at least one card from the first hand into the new hand of the second card game; and replacing at least one card in the new hand with the selected at least one card from the first hand stored in the virtual sleeve.

The above description is intended by way of example only. Although the techniques are illustrated and described herein as embodied in one or more specific examples, it is nevertheless not intended to be limited to the details shown, since various modifications and structural changes may be made within the scope and range of equivalents of the claims.

What is claimed is:

1. A gaming system comprising:
a display;
at least one input device configured to receive inputs from a user of the gaming system;
at least one processor in communication with the display and the at least one input device; and
at least one memory in communication with the at least one processor, wherein the at least one memory stores instructions that, when executed by the at least one processor, cause the at least one processor to:
initiate a first hand of a first card game, wherein the first hand includes a plurality of cards dealt to a user of the gaming system, the plurality of cards being selected from a set of cards associated with the first card game;
receive an input from the user to implement a holdout feature in the first card game, wherein the holdout feature allows the user to select at least one card of the plurality of cards from the first hand to store to a virtual sleeve;
store the selected at least one card of the plurality of cards from the first hand in the virtual sleeve;
initiate a new hand of a second card game, the second card game being initiated upon completion of the first card game;
receive an input from the user to insert the selected at least one card from the first hand into the new hand of the second card game; and
replace at least one card in the new hand with the selected at least one card from the first hand stored in the virtual sleeve.

2. The gaming system of claim 1, wherein replacing the at least one card in the new hand comprises storing the replaced at least one card from the new hand in the virtual sleeve.

3. The gaming system of claim 1, wherein replacing the at least one card in the new hand comprises returning the replaced at least one card from the new hand to a set of discarded cards.

4. The gaming system of claim 1, wherein the virtual sleeve is stored on a non-transitory, removable media storage device.

5. The gaming system of claim 1, wherein the gaming system is part of a network of a plurality of gaming systems; and
wherein the virtual sleeve is accessible by the user at each gaming system of the plurality of gaming systems in the network.

6. The gaming system of claim 5, wherein the virtual sleeve is associated with the user of the gaming system.

7. The gaming system of claim 1, wherein the virtual sleeve comprises at least three slots for storing selected cards.

8. The gaming system of claim 7, wherein the holdout feature includes multiple levels; and
wherein each level of the holdout feature allows the user to store an additional card in one of the at least three slots of the virtual sleeve.

9. A method of operating a gaming system comprising a display, at least one input device, a processor, and a memory, the method comprising:
initiating, by the at least one processor of the gaming system, a first hand of a first card game, wherein the first hand includes a plurality of cards dealt to a user of the gaming system, the plurality of cards being selected from a set of cards associated with the first card game;
receiving an input from the user to implement a holdout feature in the first card game, wherein the holdout feature allows the user to select at least one card of the plurality of cards from the first hand to store to a virtual sleeve;
storing the selected at least one card of the plurality of cards from the first hand in the virtual sleeve;
initiating a new hand of a second card game, the second card game being initiated upon completion of the first card game;
receiving an input from the user to insert the selected at least one card from the first hand into the new hand of the second card game; and
replacing at least one card in the new hand with the selected at least one card from the first hand stored in the virtual sleeve.

10. The method of claim 9, wherein replacing the at least one card in the new hand comprises storing the replaced at least one card from the new hand in the virtual sleeve.

11. The method of claim 9, wherein replacing the at least one card in the new hand comprises returning the replaced at least one card from the new hand to a set of discarded cards.

12. The method of claim 9, wherein the virtual sleeve is stored on a non-transitory, removable media storage device.

13. The method of claim 9, wherein the gaming system is part of a network of a plurality of gaming systems; and
wherein the virtual sleeve is accessible by the user at each gaming system of the plurality of gaming systems in the network.

14. The method of claim 13, wherein the virtual sleeve is associated with the user of the gaming system.

15. The method of claim 9, wherein the virtual sleeve comprises at least three slots for storing selected cards.

16. The method of claim 15, wherein the holdout feature includes multiple levels; and
wherein each level of the holdout feature allows the user to store an additional card in one of the at least three slots of the virtual sleeve.

17. A non-transitory computer readable storage media encoded with instructions that, when executed by a processor of a gaming system, cause the processor to perform operations comprising:
initiating a play of first hand of a first card game, wherein the first hand includes a plurality of cards dealt to a user of the gaming system, the plurality of cards being selected from a set of cards associated with the first card game;
receiving an input from the user to implement a holdout feature in the first card game, wherein the holdout feature allows the user to select at least one card of the plurality of cards from the first hand to store to a virtual sleeve;
storing the selected at least one card of the plurality of cards from the first hand in the virtual sleeve;
initiating a new hand of a second card game, the second card game being initiated upon completion of the first card game;
receiving an input from the user to insert the selected at least one card from the first hand into the new hand of the second card game; and
replacing at least one card in the new hand with the selected at least one card from the first hand stored in the virtual sleeve.

18. The non-transitory computer readable storage media of claim 17, wherein the gaming system is part of a network of a plurality of gaming systems; and
wherein the virtual sleeve is accessible by the user at each gaming system of the plurality of gaming systems in the network.

19. The non-transitory computer readable storage media of claim 17, wherein the virtual sleeve is associated with the user of the gaming system.

20. The non-transitory computer readable storage media of claim 17, wherein the holdout feature includes multiple levels; and
wherein each level of the holdout feature allows the user to store an additional card in one of at least three slots of the virtual sleeve.
